(19) United States
(12) Patent Application Publication
(10) Pub. No.: US 2014/0097705 A1
(43) Pub. Date: Apr. 10, 2014

(54) METHOD FOR OPERATING A POWER SOURCE AND A DEVICE FOR DISCONNECTING A POWER SOURCE FROM A CONSUMER

(71) Applicant: M & S sectec GbR, Neutraubling (DE)

(72) Inventors: Stephan CZECH, Donaustauf (DE); Manuel CZECH, Windorf (DE); Andreas DENNERLE, Regensburg (DE)

(73) Assignee: M & S sectec GbR, Neutraubling (DE)

(21) Appl. No.: 14/045,977

(22) Filed: Oct. 4, 2013

(30) Foreign Application Priority Data
Oct. 5, 2012 (DE) 102012019556.7

(51) Int. Cl. H02J 4/00

(52) U.S. Cl. CPC H02J 4/00
USPC 307/131

(57) ABSTRACT

The invention relates to a method for operating a power source, wherein in a first operating state a current supplied by the power source via a power supply line is fed to a consumer and wherein in a second operating state a feed of a current supplied by the power source via a power supply line to the consumer is interrupted by a separator. a separator associated with the power source sends an identifier via the power supply line to a control unit associated with the consumer, when the power source supplies current. The first operating state is executed when the control unit returns an expected signal within a predefined time interval (td) via the power supply line and the second operating state is executed when another signal or no signal is returned within a predefined time interval (td) via the power supply line.

### CROSS-REFERENCE TO RELATED APPLICATIONS

This application claims the benefit of German Application No. 102012019556.7 filed Oct. 5, 2012, the contents of which are incorporated herein by reference.

The invention relates to a method for operating a power source according to the preamble of patent claim 1 and a device for disconnecting a power source from a consumer according to the preamble of patent claim 7.

Methods and devices of this kind are used in the field of photovoltaics. A direct current generated by photovoltaic modules used as power sources usually arranged on a roof of a building is supplied to a consumer configured as an inverter at a high voltage possibly in the kV range. In such circuit arrangements the inverter often comprises a separator behind the power source for de-energising purposes. However, the fact remains that the supply line between the photovoltaic plant and the separator of the inverter is still live, therefore requiring great care when carrying out maintenance work. In case of a fire in a building equipped with such a photovoltaic plant, the fire brigade often has no choice but to let the building burn down in a controlled manner because the live power lines between the photovoltaic modules and the inverter represent an incalculable risk.

Furthermore there exist circuit breakers which must be actively triggered. Thereby, it is common practice to safeguard the current total of a number of power sources such as current-generating cells by arranging a circuit breaker in front of the feed-in into the subsequent node. The circuit breaker exposed to high current totals must be actively triggered by cable control or by remote radio control. Partial failure of one of the components involved leads to failure of the safeguarding system so that a safe switch-off or safe isolation of the power source from the remaining infrastructure respectively cannot be guaranteed.

However there also exist circuit breakers in module form which are passively triggered. These circuit breakers are triggered by a physical property of the risk to be protected against. A fire protection switch, for example, isolates the single power source from the subsequent infrastructure by melting down the connection in this way. No association can, however, be made if and when this safeguard is triggered, and the same is true when performing non-risk-related triggering for maintenance purposes.

Therefore, both during assembly and maintenance and in emergency situations such as when fighting a fire, non-isolatable power sources are a considerable danger to the personnel engaged in assembly and maintenance work, or to the rescuers fighting the emergency situation. In order to be able to act within often considerable distances between a power source and the nearest separator, it is desirable to isolate the power source from the infrastructure because the increase in safety to be achieved is considerable. An appropriate separator could, for example, deactivate battery cells in emergency power systems, individual cells in battery packs of electric or hybrid vehicles or modules of photovoltaic generators.

It is therefore the requirement of the invention to propose a method for operating a power source and a device for disconnecting a power source from a consumer, with which disconnection of a power source from the infrastructure downstream of the power source can be performed in a secure and efficient manner.

With respect to the method this requirement is met by a method with the characteristics of patent claim 1. With respect to the device, this requirement is met a device with all characteristics of patent claim 7. Advantageous designs of the invention are cited in the sub-claims.

The method according to the invention for operating a power source, wherein in a first operating state a current supplied by the power source is fed to a consumer via a power supply line and wherein in a second operating state the supply of a current supplied by the power source to a consumer via a power supply line is interrupted by a separator, is characterised in that a separator associated with the power source sends an identifier to a control unit associated with the consumer via the power supply line, when the power source supplies current, and that either the first operating state is executed when the control unit returns an expected signal within a predefined time interval td via the power supply line, or the second operating state is executed when in response the control unit returns a different signal or no signal at all within a predefined time interval via the power supply line.

The device according to the invention for separating a power source from a consumer comprising a separator which can be arranged on the power source and a control unit which can be arranged remotely therefrom, preferably within the area of the consumer, wherein the power source and the consumer are connected with each other via a power supply line, is characterised in that the separator is configured to send an identifier to the control unit and in that the control unit is configured to return a signal to the separator as a response to the identifier.

Due to the method and the device according to the invention the current feed into the further infrastructure is interrupted directly in or at the power source independently of the risk to be protected against. Triggering of the separator or respectively execution of the second operating state, in which the feed of the current supplied by the power source to the consumer via a power supply line is interrupted, is effected from one of the locations remote from the power source or sources without an additional wired infrastructure or a wireless data link being required.

The method and the device according to the invention, in case of an error or a failure of only one associated component of the separator or in case of a failure of the power source, cause the entire system to be automatically switched into a safe operating state corresponding to the second operating state, where the feed of a current supplied by the power source to the consumer via a power supply line is interrupted by a separator. Correct functioning of all involved components of the device according to the invention is thus a prerequisite for the power source to supply energy to the consumer.

An unequivocal identifier is periodically sent from the separator into the communication network formed by the power supply line. The control unit, in the first operating state, responds to the identifier with a positive reply in the form of a predefined signal within a predefined time interval td. If the separator does not receive a reply or the predefined signal within the predefined time interval td, it deactivates the power output by disconnecting the power source from the remaining infrastructure and by putting the system into the second operating state, in which the feed-in of a current supplied by the power source via a power supply line to the consumer is interrupted.

A further advantage of the device according to the invention consists in that it can be retrofitted into already existing systems without a great deal of installation expenditure. Only the power source must, for this purpose, be equipped with an appropriate separator and the consumer must have an appropriate control unit fitted. The connection must be effected in such a way that an identifier sent by a separator or a signal sent by the control unit, can be applied to the power supply line between a power source such as a photovoltaic module and a consumer such as an inverter.

It is, of course, possible to integrate the device and the method according to the invention with already existing control units such as a control unit of an inverter.

The desired system behaviour is achieved by arranging a separator, which can be remotely controlled by means of a control unit arranged on or in the consumer, directly at the power source. The desired fail-safe-characteristic results from a circuit which maintains activation or respectively the first operating state, in which a current supplied by the power source via a power supply line is supplied to a consumer, only during active constant signalling by a remotely positioned control unit. This is carried out in the form of a question-and-answer game involving the identifier generated by the separator and the predefined signal generated by the control unit and corresponding to the identifier, which signal must be sent from the control unit within the predefined time interval td or respectively be received again by the separator.

The power source can be switched off selectively with the aid of the invention in that the control unit is directed not to return a signal or a predefined signal corresponding to the identifier sent by the separator, wherein the second operating state is entered in which a supply of a current supplied by the power source via a power supply line to the consumer is interrupted by a separator.

According to a first further idea of the invention the identifier sent by the separator and the signal sent by the control unit are modulated onto the power supply line. Communication between the separator and the control unit is therefore effected by modulating the communication information onto the existing power line structure.

Modulating the sent identifier and the sent signal onto the line is preferably effected in form of a packet-oriented communication protocol, wherein coding of the sent identifier and the sent signal is advantageously effected in the Manchester Code. This is particularly advantageous because the direct-current portion is equal to zero which means that when using the invention in photovoltaic plants and data transmission there is no way that fluctuating sun irradiation states can have any influence upon each other.

Thereby, it has proven to be useful to use a variant of the PLC bus protocol as a packet-oriented communication protocol for data transmission. In contrast to translating another protocol such as an X10 protocol, this protocol with its considerably expanded address range with 64000 addressable bus participants offers sufficient reserves for later expansion.

As already mentioned at the beginning, a photovoltaic module is preferably used as a power source and an inverter is used as a consumer.

The internal construction of the separator would allow operation both in parallel-connected mode and in series-connected mode.

According to a further idea of the invention the separator comprises a microcontroller, a by-pass preferably provided with a free-wheeling diode and a switch preferably provided with a MosFET and an electrolyte capacitor. These components can all be produced at low cost and are easy to handle so that the invention can be retrofitted in already existing systems in a simple and cost-effective manner.

It has proven to be particularly advantageous that the energy supply of the microcontroller is effected by the power source and the energy supply of the control unit is effected by the consumer, since no additional energy sources are required for supplying these components with energy.

If the supply to the separator becomes inadequate, i.e. if the microcontroller can no longer draw sufficient current for its operation from the power source, the supply of the microcontroller output driving the switch is no longer sufficient for achieving a through-connection. The power source, for example a photovoltaic module, then no longer passes the generated output on to the downstream infrastructure. If the lack in supply is due to a defect in the power source, the remaining string, i.e. further power sources connected thereto, functions through the free-wheeling wiring analogously to the full wiring of existing photovoltaic systems.

If the energy supply to the device according to the invention is interrupted or if part of the device according to the invention is damaged, the supply of the microcontroller output driving the switch is no longer sufficient to effect a through-connection so that the photovoltaic module can no longer pass the generated output to the downstream infrastructure. If the lack in supply is due to a defect in a single power source, the remaining string functions through the free-wheeling wiring analogously to the full wiring of a module in existing photovoltaic systems.

If the control unit or parts of the connected line infrastructure are destroyed, the separator no longer receives any signals from the control unit in response to its periodically sent identifiers. Thereafter the output of the microcontroller driving the switch is switched off. The second operating state is then assumed again, in which the feed of a current supplied by the power source via a power supply line to the consumer is interrupted by a separator.

Unknown interruptions in the communication through a drop in output or defective components also become manageable with the aid of the invention. If the separator does not receive a signal from the control unit within the predefined time interval td in response to its periodically sent identifiers, it deactivates the power output by switching off the output of the microcontroller driving the switch. The second operating state is again assumed, in which a feed of a current supplied by the power source via a power supply line to the consumer is interrupted by a separator.

Selective switching-off of the plant by e.g. fire-fighting personnel is possible with the aid of the invention. If the separator does not receive a response within the interval, it deactivates the power output by switching off the output of the microcontroller driving the switch. The second operating state is again assumed, in which a feed of a current supplied by the power source via a power supply line to the consumer is interrupted by a separator.

Instructing the operating personnel in a successful switch-off is not necessary under any circumstances, since failure of any of the components leads to the switch-off of the output of the microcontroller driving the switch and thus to deactivation of the infrastructure downstream of the power source.

The invention covers the gap which currently exists in the protection of personnel fighting a fire in photovoltaic plants. It is suitable for defining minimum safety requirements in photovoltaic plants in deactivating these prior to starting fire-extinguishing work in case of a fire in photovoltaic roof or ground installations.

Apart from its function as a mere separator, the communication path on the power supply line can also be used for communicating operational data to be obtained at the power source such as on the photovoltaic module. In conjunction with controlling output power this permits setting up a control loop for the string-optimised operation. For an operator of photovoltaic plants this offers an additional economic incentive.

The invention may also be used to monitor and control battery arrangements in emergency power systems or to monitor and deactivate high-performance battery packs in vehicle propellants.

Further objectives, advantages, features and possible applications of the present invention are to be found in the following description of exemplary embodiments in conjunction with the drawings. All described or pictorially illustrated features form the subject of the present invention, either on their own or in any meaningful combination, including independently from their summary in the claims or reference thereof.

In the drawings

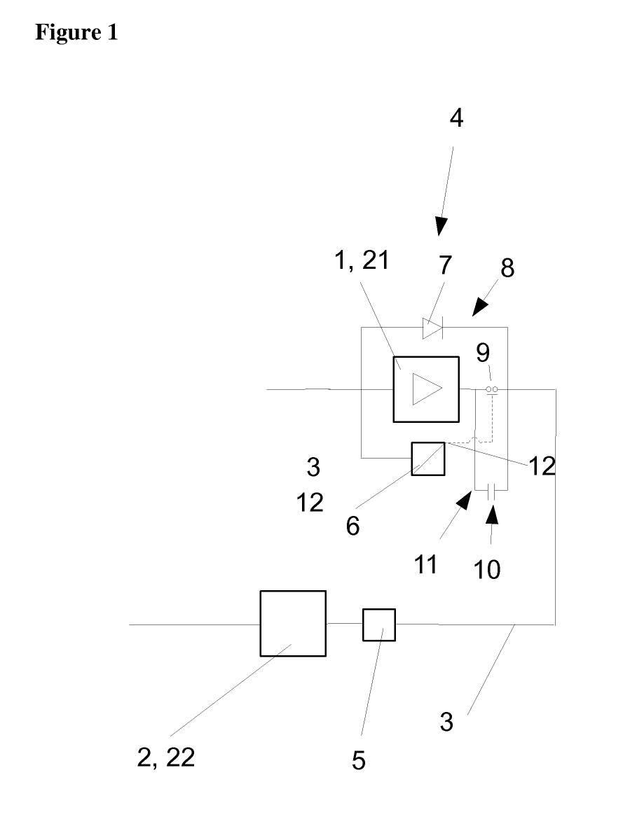

FIG. 1 shows an embodiment of a device employed in a photovoltaic system as a schematic illustration,

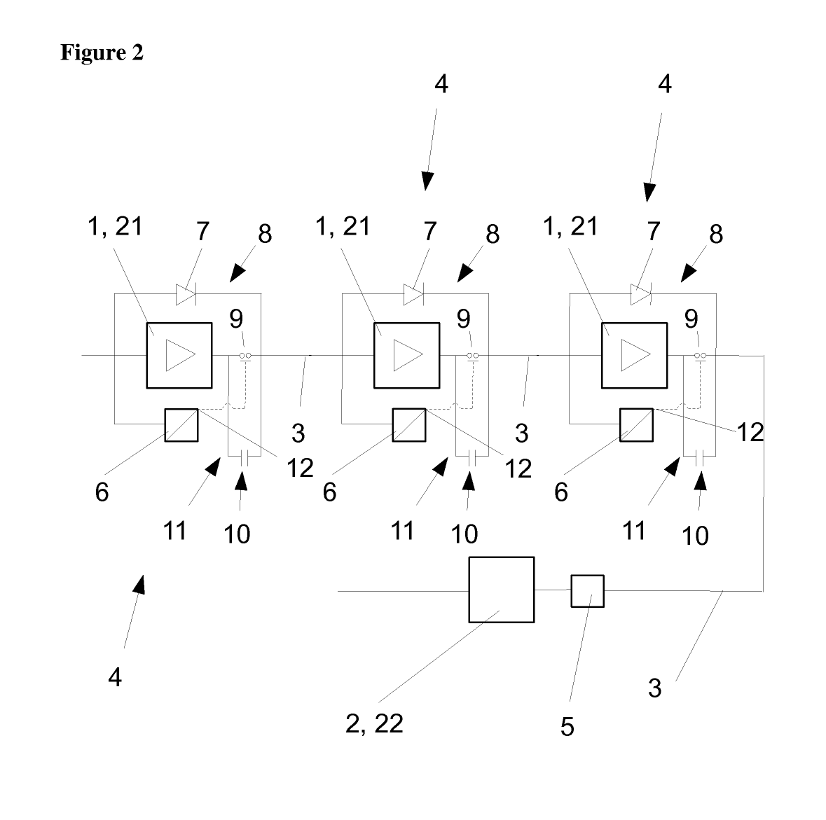

FIG. 2 shows three series-connected photovoltaic modules, each with a separator of a device according to the invention shown in FIG. 1 and a control unit arranged upstream or in an inverter, of the device according to the invention shown in FIG. 1 in a schematic illustration, and

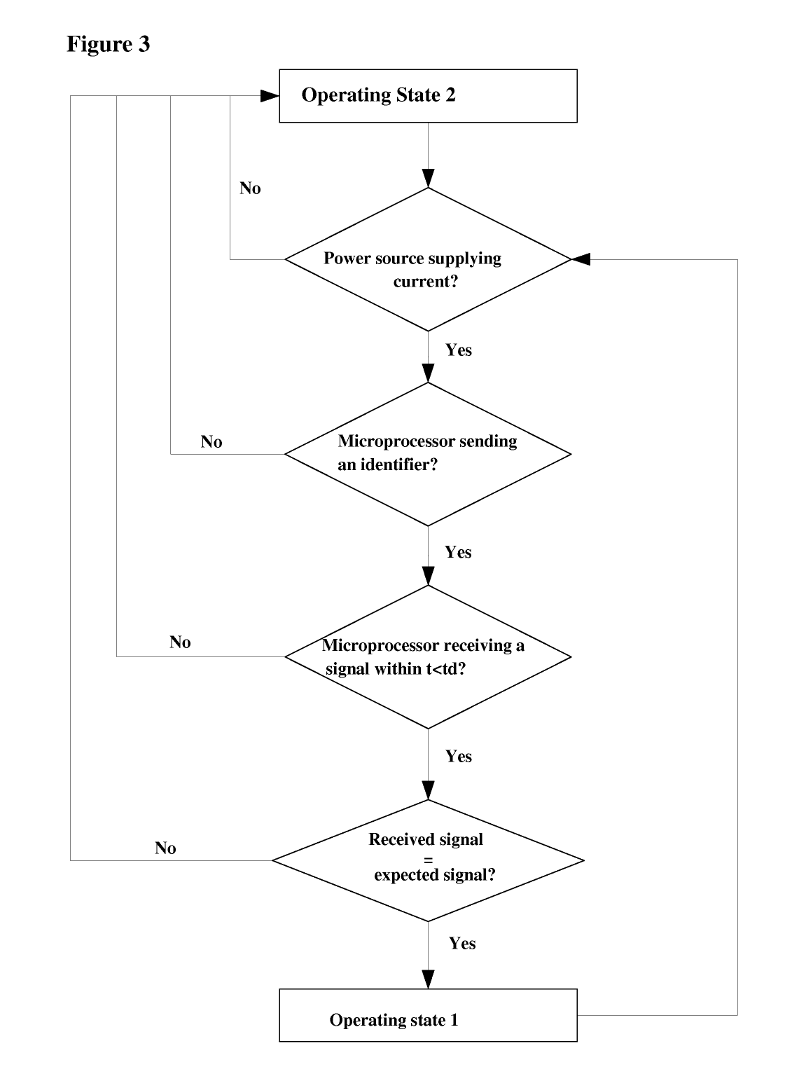

FIG. 3 shows a flow diagram of a method according to the invention.

FIG. 1 shows an embodiment of a device according to the invention by way of example of a photovoltaic system. Thereby, a photovoltaic module 21 forming a power source 1 in the present embodiment is connected with an inverter 22 configured as a consumer 2 via a power supply line 3. The photovoltaic module 21 has a separator 4 arranged on or in it and this can be used to deactivate the power supply line 3.

The separator 4 essentially consists of a microcontroller 6 controlling the separator 4, a by-pass 8 comprising a free-wheeling diode 7 and a mosFET 9 connected in parallel with an electrolyte capacitor 10. The parallel connection of the mosFET 9 together the electrolyte capacitor 10 is configured thereby as a switch 11, which allows switching the power supply line 3 to either let the current generated by the photovoltaic module 21 pass to the inverter 22, and on the other hand, to allow disconnection of the power supply line 3 directly downstream of the photovoltaic module 21, so that the power supply line 3 directly downstream of the mosFET 10 is without current. Activation of the switch 11 is effected by the microcontroller 6 which, for this purpose, comprises an output 12 with which the mosFET 9 can be switched accordingly.

The state which allows the passage of current between the photovoltaic module 21 and the inverter 22 is, in terms of the invention, defined as the first operating state and the state in which the power supply line 3 is disconnected downstream of the photovoltaic module 21 is defined as the second operating state.

A control unit 5 belonging to the device according to the invention is arranged on or respectively in the inverter 22. Although the control unit 5 is part of the device according to the invention, a control device already existing in the inverter 22 may be used as the control unit 5, so that a separate control unit is not obligatory.

The separator 4 or respectively its microcontroller 6 is configured to modulate an identifier identifying the photovoltaic module 21 and, as required, a serial number in the form of a packet-oriented communication protocol onto the power supply line 3. Coding of the sent identifier is effected using the Manchester Code. Modulating the packet-oriented communication protocol onto the line starts as soon as the energy supplied by the photovoltaic module 21 is sufficient to drive the separator 4 or the microcontroller 6.

Similarly the control unit 5 is configured to modulate a signal in the form of a packet-oriented communication protocol onto the power supply line 3. Coding of the sent signal is thereby also effected using the Manchester Code. Modulating the packet-oriented communication protocol onto the line starts when the control unit 5 receives an identifier sent by the separator 4 or the microcontroller 5 via the power supply line 3, wherein the energy supply of the control unit 5 is effected via the inverter 22.

In FIG. 2 three photovoltaic modules 21 equipped with a separator 4 shown in FIG. 1 are series-connected and these are connected with an inverter 22 via a power supply line 3. The inverter 22 has a control unit 5 arranged in or on it, which control unit communicates in the above-described manner with the separators 4 or the microcontrollers 6 of the individual photovoltaic modules 21.

It is of course possible that individual photovoltaic modules 21 may fail without affecting the current flow between the other photovoltaic modules 21 and the inverter 22, since the by-pass 8 with its free-wheeling diode 7 enables the failed photovoltaic modules 21 to be by-passed. The mosFET 9 of the failed photovoltaic module 21 in this case is switched to interrupt because the corresponding microcontroller 6, via its output 12, has performed the appropriate switching of the mosFET 10, or this operating state was assumed because the microcontroller 6 was no longer supplied with energy from the photovoltaic module 21.

FIG. 3 finally shows a flow diagram of a possible method according to the invention, wherein however, only the communication between one separator 4 of a photovoltaic module 21 and one control unit 5 of an inverter 22 is described. Naturally it is also possible for the control unit 5 to communicate with separators 4 of several photovoltaic modules 21.

To start with the second operating state has been assumed, at which the supply of a current supplied by the photovoltaic module 21 via a power supply line 3 to the inverter 22 has been interrupted by the separator 4. As soon as the photovoltaic module 21 supplies sufficient energy in form of an electric current for operating the separator 4 or respectively the microcontroller 6, a first query is performed and a decision made in the microcontroller 6.

This query consists of whether the photovoltaic module 21 as power source 1 supplies current above a certain threshold. If the answer is NO, the second operating state is maintained, so that current cannot flow through the power supply line 3 to the consumer 2 configured as inverter 22.

However, if the answer to the query is YES, a second query is performed. The second query is whether the microprocessor 6 has sent an identifier via the power supply line 3 to the control unit 5 of the inverter 22. If the answer to this query is also NO, which indicates that there is a defect in the separator 4 or respectively the microcontroller 6, the second operating state is maintained so that still no current is able to flow through the power supply line 3 to the consumer 2 configured as inverter 22.

If, however, the answer to the second query is YES, a third query follows inquiring as to whether the microprocessor 6 receives a signal within a predefined time interval td via the power supply line 3, which signal would be sent by the control unit 5 in response to the identifier. It the answer to this query is also NO, the second operating state is maintained with the result that still no current flows through the power supply line 3 to the consumer 2 configured as an inverter 22.

If, however, the answer to the third query is YES, a fourth final query ensues as to whether the signal sent from the control unit 5 via the power supply line 3 and/or received by the separator 4 or the microcontroller 6 corresponds to an expected signal or not. If the answer to this query too is NO, the second operating state is maintained, so that still no current can flow through the power supply line 3 to the consumer 2 configured as an inverter 22.

If, however, the answer to this fourth query is YES, the microcontroller 6, via its output 12, instructs the switch 11 or the mosFET 9 not to maintain the second operating state but to switch the mosFET 9 to through-passage so that the current generated by the photovoltaic module 21 configured as a power source can flow through the power supply line 3 to the consumer 2 configured as an inverter 22, which corresponds to the above described first operating state.

Then begins a new cycle of queries one to four. The periodic cycle of these queries takes place continually at a predefined frequency. The expert would derive this predefined frequency from the maximum data transmission rate within the existing line infrastructure and from the number of separators 4 to be queried. Such a polling frequency ensures that the device according to the invention with the method according to the invention deactivate the power supply line 3 between the power source 1 configured as the photovoltaic module 21 and the inverter 22 configured as the consumer 2 within a very short time so that any endangerment of operating or maintenance personnel is practically impossible even if a single component of the system should fail.

Furthermore, the control unit can be made to send no more signal or a another signal not corresponding to the identifier sent by the separator 4 or the microcontroller or another signal than the expected predefined signal via the power supply line 3 to the separator 4 or the microcontroller 6. In this way the power supply line 3 can be selectively deactivated by operating or maintenance personnel or, in emergency situations, by rescuing forces. Insofar, due to the invention, there is no longer any need to let a building burn down in a controlled manner if the photovoltaic plant is equipped with a device according to the invention, which is operated by a method according to the invention.

List of Cited References

1 power source

2 consumer

3 power supply line

4 separator

5 control unit

6 microcontroller

7 free-wheeling diode

8 by-pass

9 mosFET

10 electrolyte capacitor

11 switch

12 output

21 photovoltaic module

22 inverter

Td predefined time interval

1. A method for operating a power source, wherein in a first operating state a current supplied by the power source via a power supply line is fed to a consumer and wherein in a second operating state a feed of a current supplied by the power source via a power supply line to the consumer is interrupted by a separator,
characterised in that a separator associated with the power source supplies an identifier via the power supply line to a control unit associated with the consumer when the power source supplies current, and in that
a) the first operating state is executed when, in response, the control unit returns an expected signal within a predefined time interval (td) via the power supply line or
b) the second operating state is executed when, in response, the control unit returns another signal or no signal within a predefined time interval (td) via the power supply line.

2. The method according to claim 1, wherein the identifier sent from the separator and the signal sent from the control unit is modulated onto the power supply line.

3. The method according to claim 2, wherein modulation of the sent identifier and the sent signal is effected in the form of a packet-oriented communication protocol.

4. The method according to claim 1, wherein coding of the sent identifier and the sent signal is effected in Manchester Code.

5. The method according to claim 1, wherein the packet-oriented communication protocol used is a variant of the PLC bus protocol or a variation of the one-wire bus protocol for data transmission.

6. The method according to claim 1, wherein the power source used is a photovoltaic module and that the consumer used is an inverter.

7. A device for disconnecting a power source from a consumer, preferably for use in a method according to claim 1, with a separator which can be arranged on the power source, and a control unit, which can be arranged remotely therefrom, preferably in the area of the consumer, wherein the power source and the consumer are connected with each other via a power supply line,
wherein the separator is configured to send an identifier to the control unit, and in that the control unit is configured to send a signal to the separator as a response to the identifier.

8. The device according to claim 7, wherein the separator comprises a microcontroller, a by-pass preferably provided with a free-wheeling diode and a switch preferably provided with a mosFET and an electrolyte capacitor.

9. The device according to claim 7, wherein the power source used is configured as a photovoltaic module and the consumer used is configured as an inverter.

10. The device according to claim 7, wherein the microcontroller is supplied with energy from the power source and the control unit is supplied with energy from the consumer.
